(19) United States
(12) Patent Application Publication
(10) Pub. No.: US 2004/0240962 A1
(43) Pub. Date: Dec. 2, 2004

(54) Captive screw

(76) Inventors: Wen-I Teng, Keelung (TW); Kuo-Chang Yuan, Pingjen City (TW)

Correspondence Address: BIRCH STEWART KOLASCH & BIRCH, PO BOX 747, FALLS CHURCH, VA, 22040-0747, US

(21) Appl. No.: 10/447,153

(22) Filed: May 29, 2003

(51) Int. Cl. F16B 21/18

(52) U.S. Cl. 411/353

(57) ABSTRACT

A captive screw includes a knob, a screw component, a connection component and a spring component. The knob has a first hollow section and a second hollow section, and a convex portion is formed in an inner surface of the second hollow section. The screw component has a head portion and a thread portion. The head portion is fusion-welded in the first hollow section, and the thread portion is provided through the second hollow section and protrudes from the second hollow section. One end of the connection component has a sticking portion and a recess portion with an opening toward the head portion of the screw component. The sticking portion includes a wedging bevel. Therefore, when being stuck into the second hollow section, the sticking portion is wedged with the convex portion of the second hollow section. The thread portion is further thrown through the spring component and connection component. The spring component is provided in the space constructed of the second hollow section and the recess portion of the connection component.

### BACKGROUND OF THE INVENTION

1. Field of the invention

The invention relates to an attachment device, and in particular, to a captive screw for attaching two panels, or similar objects.

2. Description of the Related Art

It is common to use screws to attach one target object to another target object. Screws are cheap and useful and they are in widespread use throughout our daily life. However, conventional screws are not part of the target object before being mounted on the target object and therefore are often lost. Furthermore, it is necessary to use tools, such as a hammer or a screwdriver, to attach or remove conventional screws, which is inconvenient.

To solve the previous-mentioned problem, people skilled in the art have disclosed a captive screw as described in U.S. Pat. No. 6,468,012. In this case, the captive screw can be attached or removed with hands, hand tools, or electric tools. The disclosed captive screw is mounted to a first target object in such a way that the screw stays attached to the first target object even when the threads of the screw are fully disengaged from a threaded hole in a second target object to which the first target object is attached. Thus, the captive screw is kept in position-on the first target object without losing items.

With referring to FIG. 1, a conventional captive screw 2 is composed of a knob 22, a screw component 21, a spring component 23, and a connection component 24. The knob 22 is made of metal, and has a first hollow section 221 and a second hollow section 222. An opening edge 223 of the second hollow section 222 is originally a straight structure. The screw component 21 has a head portion 211 and a thread portion 212. One end of the connection component 24 has an annular flange 241.

In view of the captive screw 2, when assembling the captive screw 2 as shown in FIG. 2, the head portion 211 of the screw component 21 is punched into the first hollow 221 of the knob 22. The thread portion 212 is therefore positioned in the second hollow section 222 of the knob 22 and protrudes from the opening edge 223 of the second hollow section 222. After that, the thread portion 212 of the screw component 21 is passed through the spring component 23, which is positioned in the second hollow section 222 of the knob 22. Finally, the connection component 24 and the knob 22 enclose the spring component 23, wherein the annular flange 241 of the connection component 24 is located in the second hollow section 222 of the knob 22. Then, the opening edge 223 of the second hollow section 222 is punched and reshaped into an opening edge 223′ as shown in FIG. 2, whereby the annular flange 241 wedges with the opening edge 223′.

As mentioned above, since the knob 22 of the conventional captive screw 2 is made of metal, it is necessary to punch the head portion 211 of the screw component 21 for inserting the head portion 211 into the first hollow section 221. In addition, since the knob 22 of the conventional captive screw 2 is made of metal, it is necessary to punch the connection component 24 for wedging the annular flange 241 with the knob 22. In summary, the conventional captive screw 2 requires two punching processes. People skilled in the art should know that a mold is necessary before the punch process. During the punch process, items of the captive screw are placed in the mold manually, so the process becomes complex and dangerous. Moreover, since there are errors between the orientation of the items of the captive screw and the orientation of the punching machine while placing the items in the mold, the captive screw is often damaged during the punching process. Therefore, eliminating the punch processes can correspondingly increase the manufacturing speed and yield. Furthermore, since it is necessary to punch and reshape the opening edge 223, the opening edge 223 is usually manufactured thinner. Consequently, the reshaped opening edge 223′ is not rigid enough due to the thinner structure.

Hence, it is an important objective of the invention to provide a captive screw to avoid the dangerous and complex punch processes, and to reduce the production cost.

### SUMMARY OF THE INVENTION

In view of the above-mentioned problems, an objective of the invention is to provide a captive screw, wherein the punch processes are unnecessary.

The invention is characterized in that a convex portion is formed inside a second hollow of a knob, and the convex portion wedges with a sticking portion of a connection component having a wedging bevel. Thus, the connection component can be pushed, and then be wedged in the second hollow of the knob.

To achieve the above-mentioned objective, a captive screw of the invention includes a screw component, a knob, a connection component, and a spring component. In the invention, the knob has a first hollow section and a second hollow section, wherein the second hollow section has an inner surface, on which a convex portion is formed. The screw component has a head portion and a thread portion. The head portion of the screw component is fusion-welded in the first hollow section of the knob. The thread portion is provided through the second hollow section of the knob and protrudes from the second hollow section. One end of the connection component provides a sticking portion having a wedging bevel and a recess portion having an opening facing to the head portion of the screw component. The sticking portion is stuck into the second hollow section, so that the sticking portion can wedge with the convex portion of the second hollow section. The thread portion is also provided through the spring component and the connection component. The spring component is set in a space constructed of the second hollow section and the recess portion.

As mentioned above, since the captive screw of the invention has a convex portion, which is formed on the inner surface of the second hollow section of the knob, to restrict the connection component to move in a limited range. The sticking portion of the connection component has a wedging bevel for sticking, so the connection component can be pushed to insert into the second hollow section of the knob. Therefore, the conventional punch process for reshaping the opening edge of the second hollow section is unnecessary. In addition, since the opening edge is not necessary to get thinner for the conventional punch process, the opening edge of the second hollow section of the knob according to the invention is manufactured more rigidly than prior invention. Moreover, because the punch process is not required, it is unnecessary to manufacture the knob with raw materials having good malleability. Therefore, a polymer material, which is cheaper than metal materials, is a possible raw material for manufacturing the knob, and a thermal fusion-welded method can be used as a substitute for the punch process during mounting the head portion of the screw component in the first hollow. Consequently, the polymer might be fused and then penetrates into the indentations of the head portion of the screw component, so the contact surface between the knob and head portion is increased. Thus, the head portion can be efficiently fastened on the knob. As a result, the production cost is reduced, the manufacturing processes are simplified, and the production yield and stability are increased.

### BRIEF DESCRIPTION OF THE DRAWINGS

The invention will become more fully understood from the detailed description given in the herein below illustration, and thus are not limitative of the present invention, and wherein:

FIG. 1 is an exploded view showing a conventional captive screw;

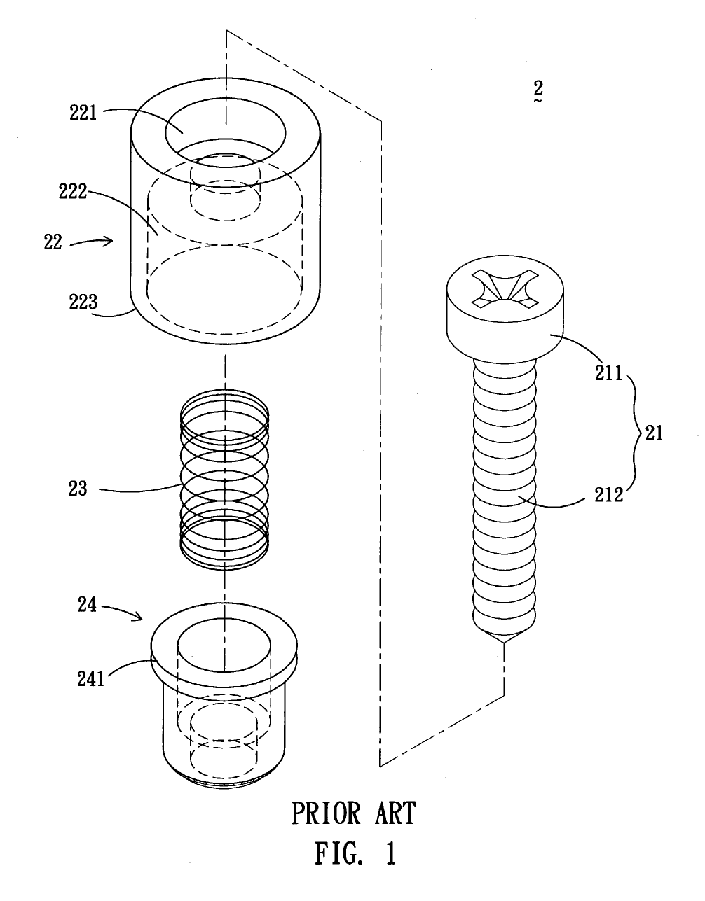

FIG. 2 is a sectional view showing the conventional captive screw;

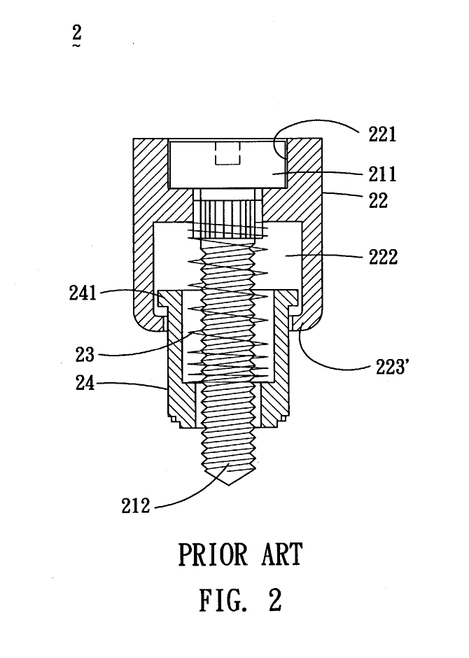

FIG. 3 is an exploded view showing a captive screw according to a preferred embodiment of the invention;

FIG. 4 is a sectional view showing a captive screw according to the preferred embodiment of the invention; and

FIG. 5 is a side view showing an outward appearance of a captive screw according to the preferred embodiment of the invention.

### DETAILED DESCRIPTION OF THE INVENTION

The captive screw according to the preferred embodiment of the invention will be described herein below with reference to the accompanying drawings, wherein the same reference numbers refer to the same elements.

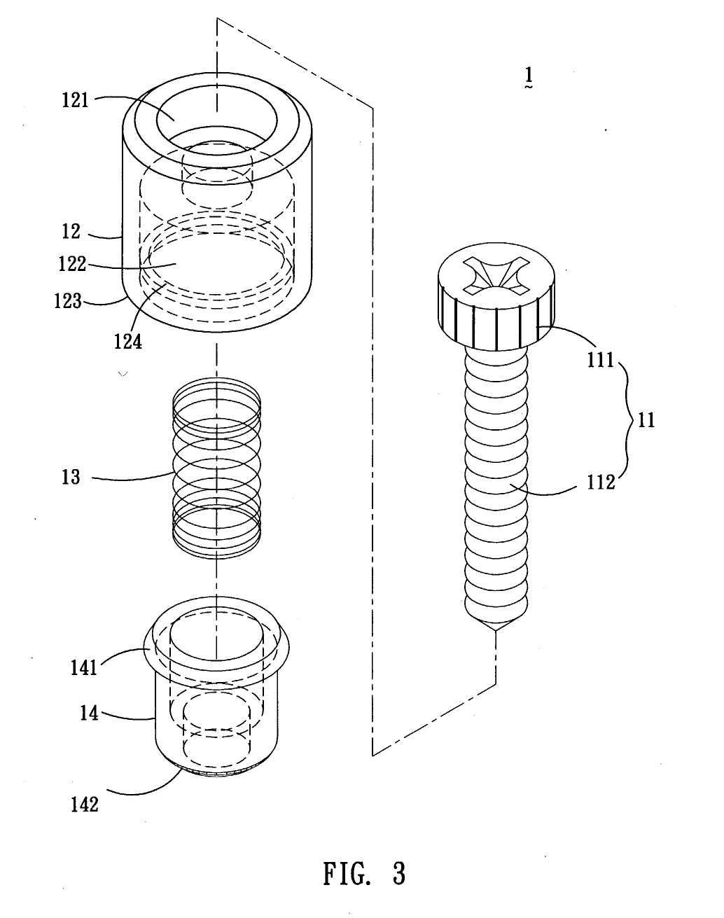

With reference to FIG. 3, a captive screw 1 according to a preferred embodiment of the invention includes a screw component 11, a knob 12, a connection component 14, and a spring component 13.

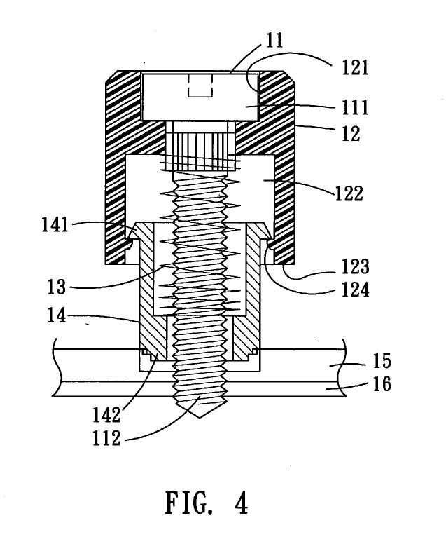

Please refer to FIG. 4. The knob 12 is made of polymer materials such as plastic materials, and has a first hollow section 121 and a second hollow section 122. A convex portion 124 is formed on the inner surface of the second hollow section 122. The structure of the convex portion 124 can be projecting spots, an annular flange, or an annular-like flange (such as a C-shaped flange or an ellipse-shaped flange). Alternatively, the convex portion 124 can be consisted of a protrusion or protrusions (not shown). Thus, people skilled in the art can operate the knob 12 manually for an attaching process or a separating process.

The screw component 11 includes a head portion 111 and a thread portion 112. The head portion 111 is fusion-welded to the first hollow section 121 of the knob 12. The screw portion 112 is provided through the second hollow section 122 of the knob 12, and protrudes from the second hollow section 122.

The connection component 14 has one end for forming a sticking portion 141 with a wedging bevel. The connection component 14 further has a recess portion facing toward the head portion 111. The sticking portion 141 is inserted into the second hollow section 122, so that the sticking portion 141 can wedge with the convex portion 124 in the second hollow section 122. The screw portion 112 is thrown through the connection component 14. In addition, the connection component 14 has an attaching portion 142 formed at the other end of the connection component 14 opposite to the sticking portion 141. Therefore, the connection component 14 can be fixed on the first target object 15 with the attaching portion 142. The screw portion 112 is further inserted through the first target object 15 and the second target object 16 so as to attach the first target object 15 to the second target object 16.

The spring component 13 is provided in a space constructed of the second hollow section 122 of the knob 12 and the recess portion of the connection component 14. As shown in FIG. 4, the thread portion 112 is provided through the spring component 13.

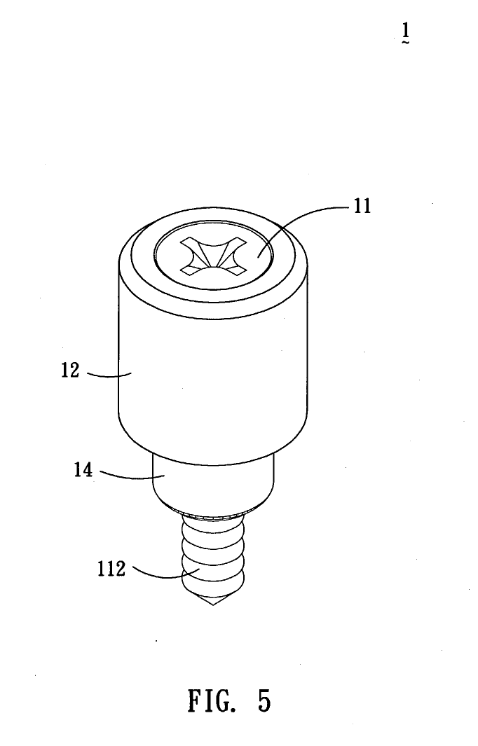

In the present embodiment, when desiring to assemble the screw component 11, knob 12, connection component 14, and spring component 13 (as shown in FIG. 4), the head portion 111 of the screw component 11 is thermal welded to the first hollow section 121 in advance. In more detail, the head portion 111 of the screw component 11 is heated, and is then inserted into the first hollow section 121 of the knob 12. In the current embodiment, the polymer material of the knob 12 is fused, and then penetrates into the indentations of the head portion 111, so that the contact surface between the knob 12 and screw component 11 is sufficiently increased. Thus, the knob 12 can be mounted to the screw component 11 efficiently. Next, the thread portion 112 of the screw component 11 is thrown into the spring component 13. Finally, the sticking portion 141 of the connection component 14 is pushed to insert into the second hollow 122, and the sticking portion 141 is wedged with the convex portion 124 of the second hollow section 122. A side view of the assembled captive screw 1 according to the preferred embodiment of the invention is shown in FIG. 5.

In summary, the captive screw 1 has the convex portion 124 formed on the inner surface of the second hollow section 122, and the sticking portion 141 of the connection component 14 has a wedging bevel. Therefore, the sticking portion 141 can be pushed for inserting into the second hollow section 122, and the conventional punching process for reshaping the opening edge 123 of the second hollow section 122 is unnecessary. Moreover, the knob 12 is made of polymer materials, which is cheaper than metal materials used for the conventional captive screw, and the fusion-welded method is used to insert the head portion 111 of the screw component 11 into the first hollow 121 of the knob 12, which results in omitting of the conventional punching process. Thus, two dangerous and complex punch processes are avoided. As a result, the production cost is reduced, the manufacturing processes are simplified, and the production yield and stability are increased.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A captive screw, comprising:
a knob having a first hollow section and a second hollow section, the second hollow section having an inner surface and a convex portion being formed on the inner surface of the second hollow section;
a screw component having a head portion and a thread portion, the head portion being fusion-welded in the first hollow section, and the thread portion being provided through the second hollow section and protruding from the second hollow section;
a connection component having a sticking portion with a wedging bevel and a recess portion having an opening facing toward the head portion of the screw component, the sticking portion being inserted into the second hollow section and wedging with the convex portion of the second hollow section, and the thread portion being provided through the connection component; and
a spring component provided in a space constructed of the second hollow section and the recess portion, the thread portion being provided through the spring component.

2. The captive screw according to claim 1, wherein the spring component is a spring.

3. The captive screw according to claim 1, wherein the convex portion is an annular flange.

4. The captive screw according to claim 1, wherein the convex portion is a substantial annular-like flange.

5. The captive screw according to claim 1, wherein the convex portion comprises at least two protrusions.

6. The captive screw according to claim 1, wherein the connection component has an attaching portion opposite to the sticking portion.

7. The captive screw according to claim 1, wherein the knob is made of a polymer material.

8. The captive screw according to claim 7, wherein the knob is made of a plastic material.
